(19) United States
(12) Patent Application Publication
(10) Pub. No.: US 2008/0291671 A1
(43) Pub. Date: Nov. 27, 2008

(54) Changeable-style luminous decorative item

(76) Inventor: Chia-Ho Lei, Taoyuan (TW)

Correspondence Address: BACON & THOMAS, PLLC, 625 SLATERS LANE, FOURTH FLOOR, ALEXANDRIA, VA, 22314-1176, US

(21) Appl. No.: 11/802,284

(22) Filed: May 22, 2007

(51) Int. Cl. F21V 23/04

(52) U.S. Cl. 362/231

(57) ABSTRACT

This invention relates to a kind of changeable-style luminous decorative item. The effect is achieved because when light sources of different colors and strengths pass through different color materials and decoration, because of light frequency absorbency (photo permeability) differences, various visual effects are produced, resulting in changes in shape, pattern and color. This allows the same object to change expression, shape or style, for example, giving a face-change effect, allowing the decorative items to be changeable and have lifelike light source color and style changes, making the product more competitive.

### BACKGROUND OF THE INVENTION

1. Field of the Invention

This invention relates to changeable-style luminous decoration item. The inside surface of the luminous decorative item has two different colors and styles. Through illumination from different colored light sources inside the luminous decorative item, luminous decorative items with lifelike styles can be created.

2. Description of the Prior Art

Most commonly-seen luminous decoration items only have one kind of facial expression or light effect. Illumination by different colored light sources in combination with different colored painting or material to produce different color and expression will be an improvement.

### SUMMARY OF THE INVENTION

The objective of this invention is to offer changeable-style luminous decorative item.

The main objective of this creative work is using changes in illumination from different colored light sources to make the contours and style of the luminous decorative item, for instance face, undergo realistic changes and make it more lifelike.

### BRIEF DESCRIPTION OF DRAWINGS

This invention is better understood by referring to the accompanying drawings, wherein:

FIG. 1 is a perspective view of a changeable-style luminous decorative in the present invention;

FIG. 2 is a rear cross-sectional view of the changeable-style luminous decorative in the present invention;

FIG. 3 is a cross-sectional view of the changeable-style luminous decorative in the present invention, showing that when light source 200 shining on coating 10 for overall illumination (1);

FIG. 4 is a cross-sectional view of the changeable-style luminous decorative in the present invention, showing that when light source 201 shining on coating 11 creating partial illumination (2); and

FIG. 5 is a partial cross-sectional view of luminous body in the present invention.

### DETAILED DESCRIPTION OF THE PREFERRED EMBODIMENT

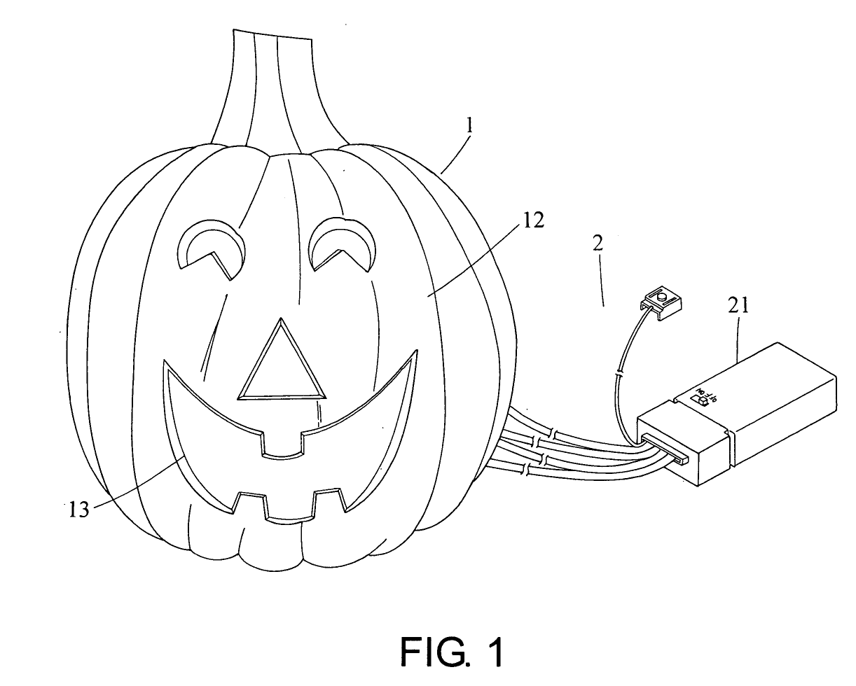

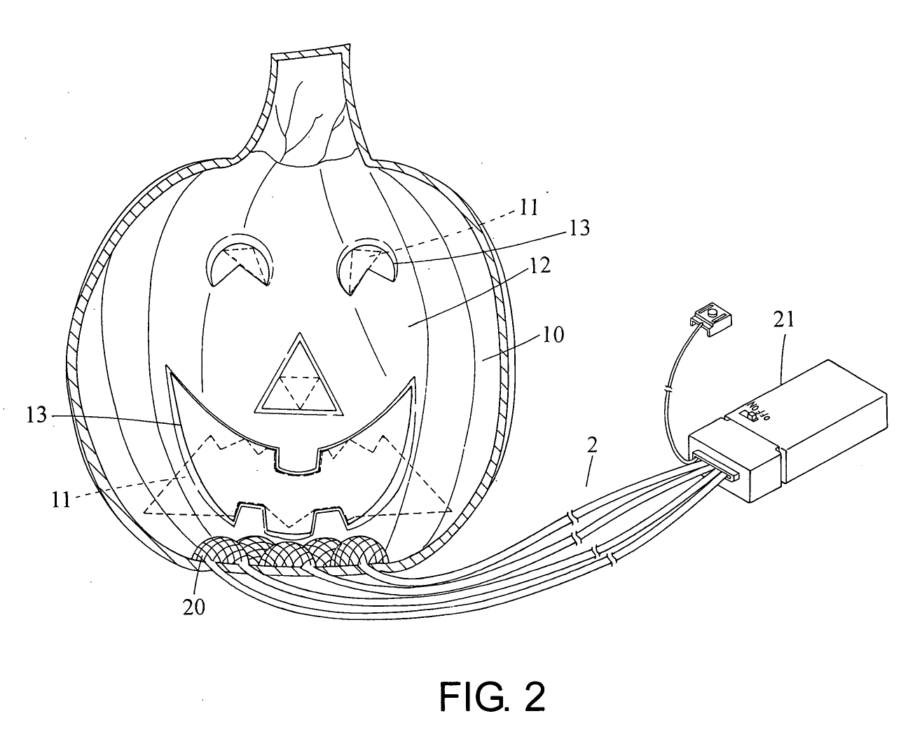

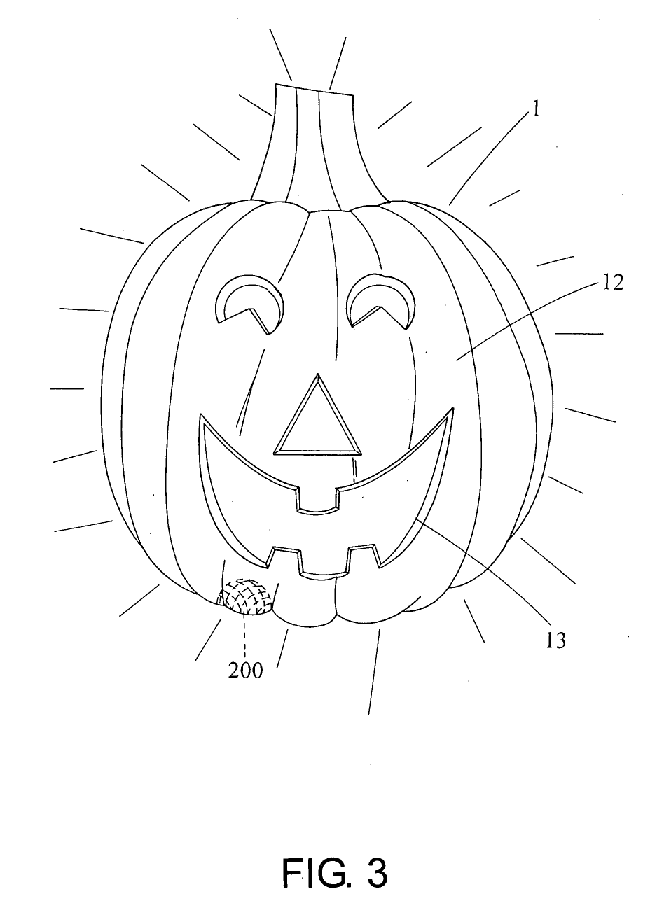

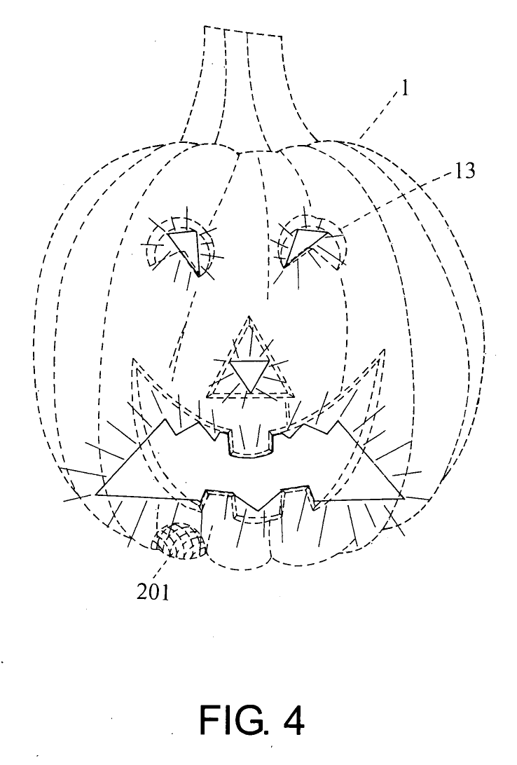

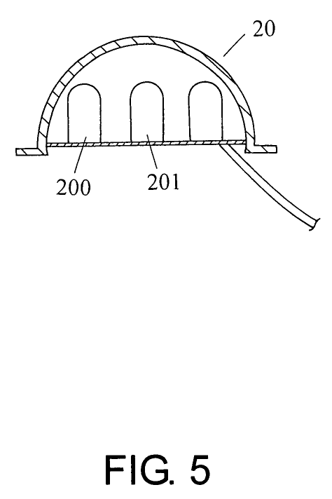

A preferred embodiment of a changeable-style luminous decorative item in the present invention, as shown in FIGS. 1 to 5, includes a hollow main body 1 and a luminous component 2 combined together.

The hollow main body 1 is made from photo permeable material and the inside surface of the hollow main body is coated with different colored coating 10 and 11 and contours and expression 12 and features and facial contours 13. Coating 10 and facial expression 12 are surface contours. Coating 11 and features and facial contours 13 are surface contours. Coating 10 can totally block out light from certain light sources.

The luminous component 2 is fitted inside hollow main body 1 or project light on the object from outside. It includes many different colored luminous bodies 20 and a power source IC control 21. The orange and red light source 200 resulting from the mutual penetration of coating 10 and facial expression 12 and the light source 201 produced by the mutual penetration of coating 11 and features and facial contours 13 are luminous body 20. The green, blue and yellow light source 201's color scheme can only illuminate features and facial contours 13 by penetrating coating 11 and, in addition, cannot penetrate coating 10 and illuminate facial expression 12. The power source IC control 21 can control light source order of light sources 200, 201 in luminous body 20.

When used by just activating the power source IC 21 on the hollow main body, the luminous body 20 in luminous component 2 will emit light. When the light source 200 of luminous body 20 produces light, a luminous color effect will make the facial features 12 of the hollow main body 1 more luminous.

When luminous body 20's light source 201 is the source of illumination, because of the luminous color effect, the hollow main body 1's facial expression 12 is because coating 10 blocks out the light and features and facial contours 13 and coating 11 will produce partial penetrating luminosity changes, making the light source 201 inside the facial features 13 of the surface of hollow main body to give off light and produce partial expression change light. This way the changes of the hollow main body 1 will be richer, the product competitiveness will also be increased.

While the preferred embodiment of the invention has been described above, it will be recognized and understood that various modifications may be made therein and the appended claims are intended to cover all such modifications that may fall within the spirit and scope of the invention.

1. A changeable-style luminous decorative item, including:
a hollow main body formed from a photo permeable material;
a first decorative pattern formed on an inside surface of said hollow main body of a first colored coating:
a second decorative pattern formed on the inside surface of said hollow main body of a second colored coating;
a luminous component fitted in the hollow main body and arranged to project light on the surface of the inside of the main body or outside of the main body, the light being changeable in color or intensity between at least a first color which interacts with said first colored coating to create an external appearance according to said first decorative pattern and a second color which interacts with said second colored coating to create an external appearance according to said second decorative pattern;
the luminous element comprising a luminous body and IC control or continuous mechanism;
wherein the IC control controls changes in color or intensity of the projected light, such that a luminous external appearance of the main body changes according to a combination of the color and intensity of the projected light and a photo permeability of the main body, first, and second colored coatings, thus making the luminous decorative item more lifelike and changeable.

2. The changeable-style luminous decorative item as claimed in claim 1, wherein said luminous body comprises light sources of which are green, blue, orange, red and yellow colors.

3. The changeable-style luminous decorative item as claimed in claim 1, further comprises a sound effect generator.

4. The changeable-style luminous decorative item as claimed in claim 1, further comprises at least one activation device, such as a switch, light sensor, sound sensor or remote control.
